(19) United States
(12) Patent Application Publication
(10) Pub. No.: US 2026/0007263 A1
(43) Pub. Date: Jan. 8, 2026

(54) System And Method for Attaching A Graphic Accessory to a Steel-Walled Drinking Vessel

(71) Applicant: Seth Collins, Mesa, AZ (US)

(72) Inventor: Seth Collins, Mesa, AZ (US)

(21) Appl. No.: 19/261,517

(22) Filed: Jul. 7, 2025

Related U.S. Application Data
(60) Provisional application No. 63/667,836, filed on Jul. 5, 2024.

(51) Int. Cl. A47G 19/22; B32B 7/12; B32B 37/12; B32B 38/00

(52) U.S. Cl. CPC A47G 19/2227; B32B 7/12; B32B 37/1284; B32B 38/145; B32B 2250/02; B32B 2307/208; B32B 2307/4023; B32B 2307/718; B32B 2307/7375; B32B 2307/7376; B32B 2451/00

(57) ABSTRACT

A customizable accessory for steel-walled insulated drinking vessels, comprising a magnetic wrap that conforms to the shape of the drinking vessel. The magnetic wrap includes a magnetic layer formed from a flexible magnetic material and a decorative layer made from a printable, wipe-clean material. The decorative layer is adhered to the magnetic layer using an industrial-strength adhesive. The accessory can be customized to fit different vessel circumferences and the magnetic layer provides a magnetic strength of at least 15 mil and a pull strength of at least 12.5 foot-pounds per square foot. The accessory is lightweight and can be manufactured by printing a design on the design layer, applying an industrial-strength adhesive to the adhesive side of the design layer, and bonding the design layer with the magnetic layer. The combined layers are then rolled tightly to retain a cylindrical shape for application to the drinking vessel.

### CROSS REFERENCE TO RELATED APPLICATIONS

This application claims benefit from currently pending U.S. Provisional Application No. 63/667,836 titled “System and Method for Attaching a Graphic Accessory to a Steel-Walled Drinking Vessel” and having a filing date of Jul. 5, 2024, all of which is incorporated by reference herein.

### BACKGROUND OF THE INVENTION

### Field of the Invention

The technology pertains to the field of customizable accessories for steel-walled insulated drinking vessels, involving magnetic and decorative layers adhering to an exterior surface of the drinking vessel and allowing user to personalize their containers with designs, logos, images, or textures. Specifically, the technology involves a multi-layer wrap that utilizes a flexible magnetic material couples with a printable surface for aesthetic modifications.

### Description of Related Art

Insulated drinkware, particularly stainless steel tumblers, has become highly popular due to their effectiveness in maintaining beverage temperature over prolonged periods. Such drinkware is available in various sizes, shapes, and features, including double-wall insulation and vacuum seals. However, alongside functionality, there is an increasing consumer demand for aesthetic customization, which has led to the development of several personalization methods.

Traditional personalization methods include decals, laser etching, and pre-printed designs. Decals are adhesive-backed decorations that can be easily applied to the drinkware but suffer from durability issues, such as peeling or wearing off over time, particularly under exposure to moisture and frequent handling. Laser etching, while providing a permanent design by engraving the drinkware surface, is limited in its ability to display vivid colors and intricate patterns and is expensive and time-intensive to customize. Pre-printed designs are restricted to the options provided by manufacturers, offering minimal room for personal customization.

Alternatives such as fabric and foam sleeves have been introduced, which can be adorned with various patterns or logos and sometimes feature magnetic elements. However, these sleeves add significant bulk and weight to the drinkware, are cumbersome to apply and remove, and often lack a seamless aesthetic. Additionally, the materials used in these sleeves tend to wear out quickly, diminishing their longevity and practical usability. Another option includes holders and carriers, which often come in the form of straps or handles to enhance portability. These items primarily address functionality and rarely serve a decorative purpose.

Existing products fail to effectively meet the growing consumer demand for a customizable, low-profile, and durable decorative solution that integrates seamlessly with steel-walled insulated tumblers. Adhesive methods currently in use face significant challenges under daily usage conditions. Stickers and decals often suffer from edge curling and complete detachment when exposed to wet conditions or physical wear. Adhesives used in these products can leave behind residue, which compromises the aesthetic appeal of the tumblers and requires intensive cleaning.

Magnetic adherence mechanisms available in the market are also inadequate in terms of providing the required magnetic strength and durability for products subjected to extensive daily use. There is no low-profile magnetic layer with sufficient pull strength to securely adhere a decorative layer to stainless steel surfaces without significant bulk.

Moreover, similar customization issues are faced in other applications involving metal surfaces, where there is a need for durable, aesthetically pleasing, and easy-to-apply decorative elements.

Technological advancements have been made in areas such as printable flexible materials and stronger, thinner magnetic substrates. Modern digital printing techniques enable the production of detailed graphics and high-resolution images on pliable surfaces like vinyl and silicone. Developments in adhesive technologies, including 3M industrial hold spray adhesives and two-compound resin adhesives, have also enhanced bonding strength and longevity.

What is needed is an innovative solution that leverages these advancements to provide a customizable, aesthetically versatile, and durable decorative option specifically engineered for steel-walled insulated drinkware, thereby filling the existing gap in the market and extending practical applications.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.
U.S. Pat. No. 11,713,165
U.S. Pat. No. 11,589,696
U.S. Pat. No. 11,459,162
U.S. Pat. No. 8,364,542
U.S. Pat. No. 9,877,605
U.S. Pat. No. 7,021,594
U.S. Pat. No. 7,263,790
U.S. Pat. No. 7,338,573
U.S. Pat. No. 6,286,798
U.S. Pat. No. 6,138,860
US Pub. No. 20230225530
US Pub. No. 20230043520
US Pub. No. 20230023629
US Pub. No. 20170305100
US Pub. No. 20130134174
US Pub. No. 20120091158
US Pub. No. 20040243036

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a customizable accessory for steel-walled insulated drinking vessels, allowing users to personalize their drinking vessels while maintaining the vessel's insulation properties. The accessory conforms to the shape of the drinking vessel and may vary the length of the accessory to accommodate changes in the vessels circumference.

The accessory provides a magnetic wrap made from a flexible magnetic material layer adhered to a decorative layer using an industrial-strength adhesive, ensuring a durable and long-lasting bond.

It is an object of the invention to provide a customizable accessory for a metal object having a wipe-clean surface for improved durability and ease of use.

It is another object of the invention to provide a removable accessory for a drinking vessel that is easily removed for washing the drinking vessel without wearing the accessory.

It is another object of the invention to allow users to add color and personalization to their hydration vessels.

It is another object of the invention to prove a low-profile accessory for a metal object for an improved sleek appearance.

It is another object of the invention to provide an accessory that forms a strong magnetic bond with a metal object while remaining easily removable.

It is another object of the invention to provide a customizable design layer that may be magnetically applied to a metal surface.

The above and other objects may be achieved using devices involving a customizable accessory for steel-walled insulated drinking vessels, allowing users to personalize their drinking vessels while maintaining the vessel's insulation properties. The accessory is designed to conform to the shape of the drinking vessel without an air gap, ensuring a snug fit and secure placement. The invention achieves these objectives by incorporating a magnetic wrap made from a flexible magnetic material, which can be adjusted to fit a desired height and circumference.

The magnetic wrap is coupled to a decorative layer made from a printable, wipe-clean material such as vinyl, silicone, or plastic, providing both aesthetic appeal and practicality. The decorative layer is adhered to the magnetic layer using an industrial-strength adhesive, ensuring a durable and long-lasting bond. The adhesive can be selected from a group consisting of 3M industrial hold spray adhesive and a two-compound resin adhesive, providing flexibility in manufacturing and use.

The above and other objects may be achieved using methods involving manufacturing the customizable accessory. The method involves providing a magnetic layer and a low-profile design layer, printing a design on the design layer and applying an industrial-strength adhesive to the design layer to bond the design layer with the magnetic layer.

The combined layers are then rolled tightly to retain a cylindrical shape for application to the drinking vessel. The customizable accessory and the method of its manufacture offer a unique solution for personalizing and enhancing the functionality of steel-walled insulated drinking vessels. The invention provides a balance between aesthetic appeal, practicality, and durability, making it a valuable addition to the market of drinking vessel accessories. Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an isometric view of a drinking vessel bearing the accessory according to one or more embodiments of the invention.

FIG. 2 depicts a side view of a drinking vessel bearing the accessory according to one or more embodiments of the invention.

FIG. 3 depicts a back view of a drinking vessel bearing the accessory according to one or more embodiments of the invention.

FIG. 4 depicts an isometric view of an accessory in its rolled position according to one or more embodiments of the invention.

FIG. 5 depicts a front view of an accessory in its rolled position according to one or more embodiments of the invention.

FIG. 6 depicts a front view of an accessory in its unrolled position according to one or more embodiments of the invention.

FIG. 7 depicts a side view of an accessory in its unrolled position according to one or more embodiments of the invention.

FIG. 8 depicts a back view of an accessory in its unrolled position according to one or more embodiments of the invention.

FIG. 9 depicts a front view of another embodiment of accessory in its unrolled position according to one or more embodiments of the invention.

FIG. 10 depicts a back view of another embodiment of accessory in its unrolled position according to one or more embodiments of the invention.

FIG. 11 depicts a front view of yet another embodiment of accessory in its unrolled position according to one or more embodiments of the invention.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

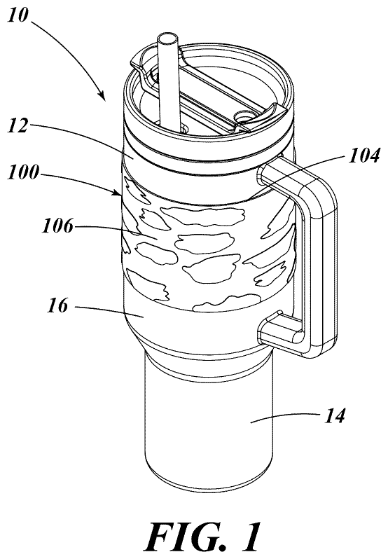

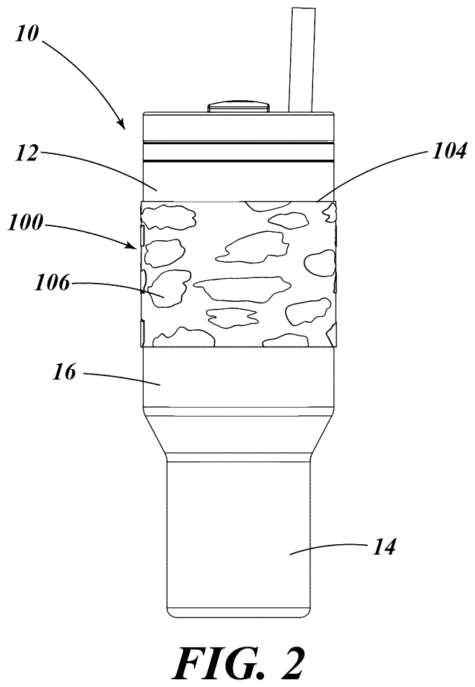

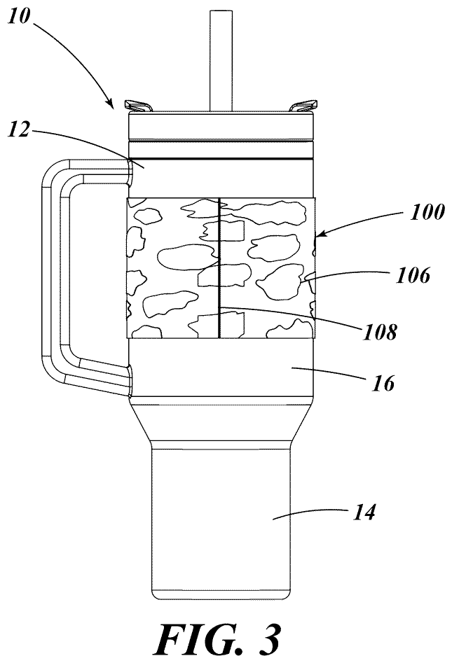

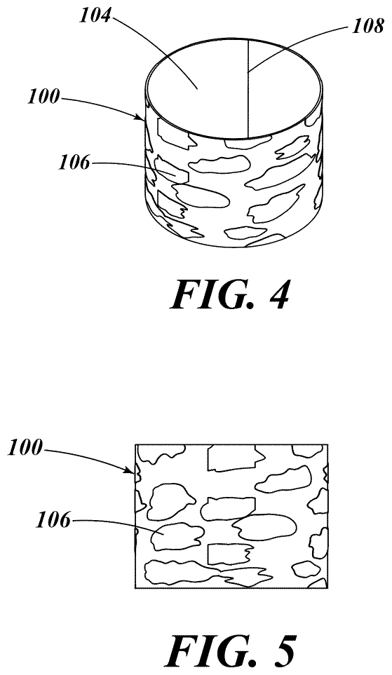

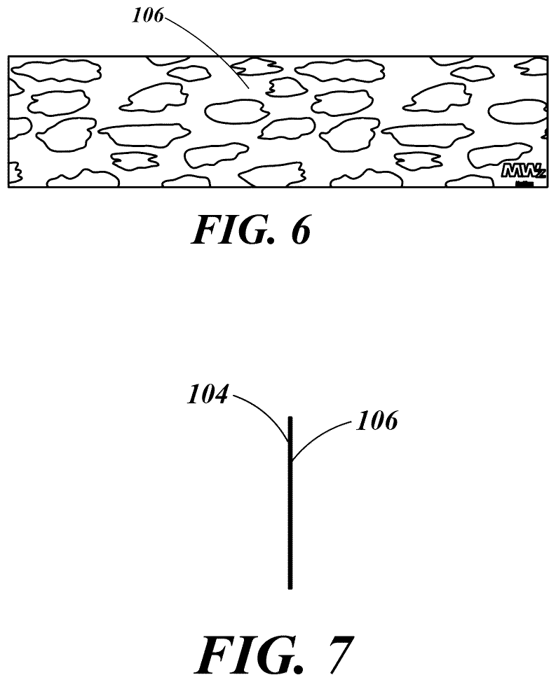

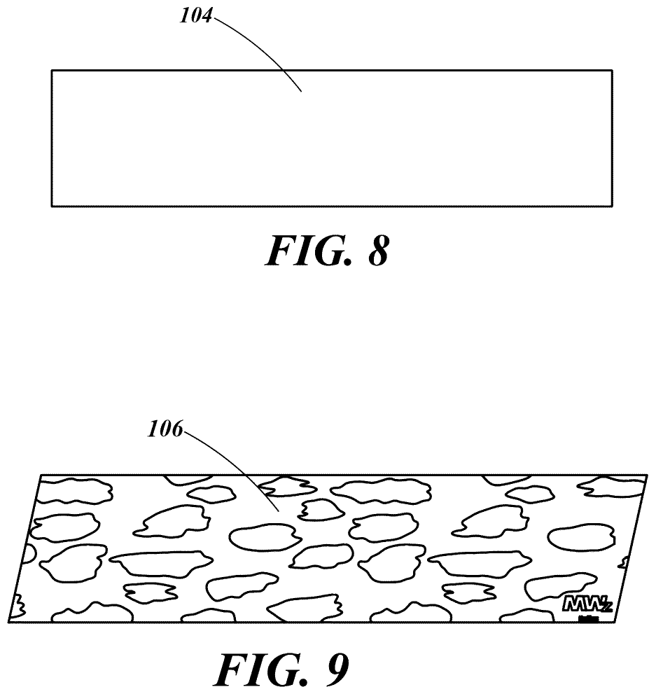

Referring to FIGS. 1-8 a customizable accessory is shown generally at 100. In one application of the invention, the customizable accessory 100 designed for steel-walled insulated drinking vessels 10 is provided facilitating the application of various decorative designs, logos, images, or textures to the exterior surface 12 of the insulated vessel. Numerous other substrates are contemplated beyond insulated drinking vessels. For example, flasks, furniture, tables, chairs, desks, shelves, home decor, picture frames, wall art, sculptures, kitchenware, pots and pans, backsplashes, range hoods, appliances, refrigerators, ovens, dishwashers, microwaves, door hardware knobs, light switches, bathroom fixtures, outdoor items, planters, patio furniture, fencing, garden sculptures, architectural elements, railings, toolboxes, bracelets, pen cases, business card holders, desk organizers, and letter openers may be customized using the described invention.

The accessory 100 comprises a multi-layer wrap 102, which includes a magnetic layer 104 coupled with a decorative layer 106, the latter of which can be personalized using various printing techniques. For example, screen printing, digital printing, UV printing, solvent printing, thermal transfer printing, dye sublimation, pad printing, flexography, gravure printing, embossing, and debossing. The choice of printing method depends on various factors, including the material, design complexity, quantity needed, and intended use of the printed product. In one embodiment, a blank decorative layer may be provided to the end user that allows the end user to print their own customized decorative layer that can then be adhered to the magnetic layer.

The magnetic layer 104 is a flexible magnetic material, formulated to maintain strong adhesion to steel-walled insulated cups, providing a magnetic strength of at least 15 mil and a pull strength of at least 12.5 foot-pounds per square foot without an air gap. The thickness of the magnetic layer contributes to the total combined thickness of the wrapped product, which may range from about 0.25 mm to about 2.5 mm and even more preferably 0.5 mm to about 1.5 mm. This magnetic layer is adapted to conform to the cylindrical shape of the tumbler when rolled tightly. The magnetic layer 104 can comprise various types of magnetic materials selected based on the specific application requirements and desired magnetic properties. Suitable magnetic materials include neodymium-iron-boron (NdFeB) magnets, which provide exceptionally high magnetic strength in thin configurations. Neodymium magnets may be formulated in grades ranging from N35 to N52, with higher grade numbers indicating stronger magnetic fields.

In the preferred embodiment the magnetic layer 104 is flexible and can have be a flexible magnetic material such as, for example, magnetic rubber or magnetic vinyl compounds which can consist of ferrite powder suspended in a flexible polymer matrix, such as natural rubber, synthetic rubber, or thermoplastic elastomers. The magnetic particles are typically oriented during the manufacturing process to achieve optimal magnetic alignment. Flexible magnetic materials can be manufactured in continuous sheets and cut to desired dimensions, making them particularly suitable for mass production of the accessory 100.

The magnetic layer 104 may incorporate hybrid magnetic configurations, such as alternating magnetic pole arrangements or variable magnetic strength zones. In one embodiment, the magnetic layer 104 comprises alternating strips of north and south magnetic poles arranged perpendicular to the wrapping direction. This configuration enhances the magnetic grip by creating multiple magnetic circuits when the accessory 10 is wrapped around the vessel. The alternating pole arrangement may comprise pole widths ranging from 1 mm to 10 mm, with optimal performance achieved with pole widths of approximately 3 mm to 5 mm.

The magnetic layer 104 may be manufactured using various production methods depending on the selected magnetic material type. Injection molding may be employed for bonded magnetic materials, allowing for precise control of magnetic particle orientation and density. Compression molding may be utilized for ferrite-based flexible magnets, providing uniform thickness and magnetic properties. For rare-earth magnetic materials, powder metallurgy processes including pressing, sintering, and machining may be employed to achieve the desired magnetic characteristics and dimensional tolerances.

The decorative layer 106 is made from materials such as vinyl, silicone, plastic, or other pliable and printable surfaces. It is attached to the magnetic layer 104 using an industrial-strength adhesive, which may include, but is not limited to, 3M industrial hold spray adhesive or a two-compound resin adhesive. The decorative layer 106 serves as the customizable exterior, capable of displaying various designs, pictures, logos, or other visual elements. The overall weight of the combined wrap is approximately 53 grams, with dimensions engineered to be roughly 3 inches in height and 12 inches in width, providing adaptability to fit the diameter of most standard tumblers.

Some steel-walled drinking vessels have a first vessel circumference 14 that transitions to a second vessel circumference 16. The accessory 100 may provide a wrap 102 that has a portion that has a first wrap length configured to conform to the first circumference 14 and a portion that has a second wrap length configured to conform to the second vessel circumference 16. In some embodiments, the accessory has a first edge and a second edge. The first edge has a first length and the second edge has a second length that is shorter than the first length. When the accessory 100 is wrapped around the drinking vessel the accessory will have a conical shape narrowing from the first length to the second length. In a particular embodiment, the accessory will have a first edge length of about 321 mm, a midline length of about 319 mm and a lower edge length of about 317 mm.

The end of the accessory 100 can be at a 90 degree angle to the edge or it may have a different angle such that the end appears to have a slant to it. be flat or have an angle. The accessory 100 can be a strip having a width of about 3 inches between the first edge and the second edge. The strip may be cut out of a flat sheet of flexible magnetic material. To achieve a conical shape, the strip may be cut at an angle of about 16° to about 23° off the 90° angle of the sheet. In another embodiment, the strip may be cut with an angle between 17° and 18° off the 90° angle of the sheet. Having the angled ends creates a seam where the two ends of the accessory strip connect when wrapped about the drinking vessel. The angle of the cut can be customized to create a conical shape that matches the variations among various tumbler designs. An additional cut may be made parallel to the slanted cut that creates the connecting seam approximately 2 to 3 inches away from the edge. This creates a flap of magnetic material that can both adhere to the flask or the material itself if the overall length of the material exceeds the circumference of the tumbler at the connecting seam. The length of the accessory 100 may be made to exceed the circumference of the vessel to create an overwrap area. The overwrap area can magnetically adhere to the vessel or to another portion of the accessory.

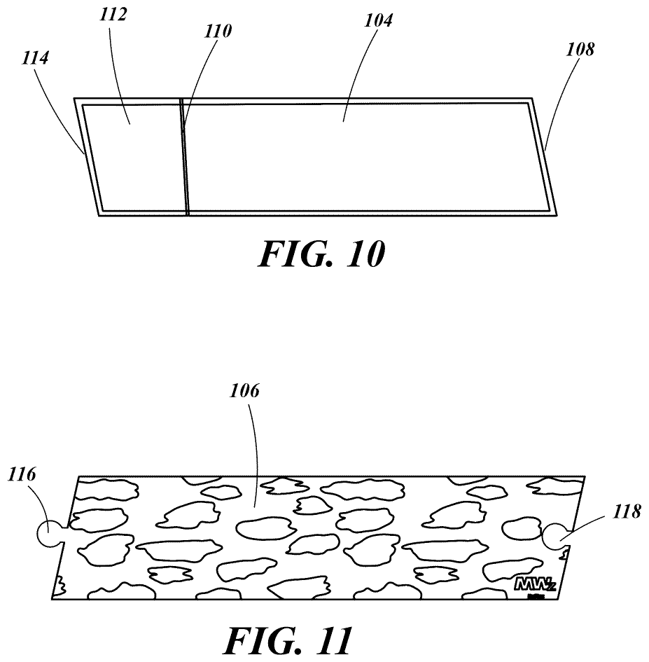

Referring to FIG. 10, the accessory 100 may be provided having a snap flap 112 that makes the accessory 10 more satisfying to wrap about the drinking vessel. The snap flap 112 is formed by having a crease 110 near one end of the accessory 100. The crease allows the snap flap 112 to hinge about the crease 112. When wrapping the accessory 100 about the drinking vessel, the first end 108 is coupled to the vessel and wrapped about the vessel. When the area about the crease is coupled to the vessel, the user can release the accessory 100 and the snap flap 112 will “snap” into place on the vessel 10. The snap flap 112 may be dimensioned to provide optimal tactile feedback when engaging with the drinking vessel. In one embodiment, the snap flap 112 has a length of approximately 0.5 to 4.0 inches measured from the crease 110 to the terminal end 114. The crease 110 may be formed through various methods including scoring, perforating, or creating a reduced thickness region in the material of the accessory 100. The depth of the crease 110 is preferably between 25% and 75% of the total thickness of the accessory material to provide adequate flexibility while maintaining structural integrity.

The snap flap 112 may further comprise an engagement surface 116 that provides enhanced grip against the drinking vessel. The engagement surface 116 may include texturing, raised elements, or adhesive properties to improve retention. In some embodiments, the engagement surface 116 comprises a series of micro-ridges or a rubberized coating that increases friction between the snap flap 112 and the vessel surface. The snapping action of the snap flap 112 is facilitated by the elastic properties of the accessory material and the angular configuration of the crease 110. When the accessory 100 is wrapped around the drinking vessel, the snap flap 112 is initially held in tension. Upon release, the stored elastic energy causes the snap flap 112 to rapidly conform to the vessel contour, creating an audible “snap” sound and providing tactile confirmation of proper engagement. This mechanism enhances user satisfaction and provides positive feedback that the accessory 10 is securely positioned. In another embodiment, the accessory 100 may include multiple snap flaps positioned at different locations along the length of the accessory to provide enhanced securing capability for vessels of varying diameters. Each snap flap may be configured with different dimensions or crease angles to accommodate different vessel geometries. In certain embodiments, the accessory 100 can adhere to itself without the drinking vessel 10.

Referring to FIG. 11, the accessory 100 may include a tab 116 on one end and a cutout 118 on the opposite end of the accessory 100. The tab 116 fits into the cutout 118 when the accessory is wrapped about the vessel. The tab 116 may be configured with a complementary shape to the cutout 118 to ensure secure engagement. In one embodiment, the tab 116 comprises a generally rectangular projection extending from the first end 108 of the accessory 100, having a width slightly less than the corresponding width of the cutout 118 to allow for easy insertion while maintaining a snug fit. The tab 116 may include beveled edges 120 or rounded corners to facilitate smooth insertion into the cutout 118 during wrapping operations. The cutout 118 may be positioned at a predetermined distance from the second end 122 of the accessory 100, with the distance calculated to accommodate various vessel circumferences. In preferred embodiments, the cutout 118 is located approximately 0.25 to 1.5 inches from the second end 122. The cutout 118 may comprise straight edges, curved edges, or a combination thereof to provide the desired retention characteristics while allowing for easy disengagement when removal is desired.

To enhance the retention capability of the tab-and-cutout system, the tab 116 may include one or more retention features such as, for example, raised bumps, ridges, or flexible barbs that provide interference fit with the edges of the cutout 118. When the tab 116 is fully inserted into the cutout 118, the retention features engage with the cutout material to resist accidental disengagement while still permitting intentional removal by the user.

In another embodiment, the accessory 100 may include multiple tabs 116 of varying sizes positioned along the first end 108, with corresponding multiple cutouts 118 positioned at different locations along the opposite end. This configuration allows for adjustable fitting to accommodate drinking vessels of different diameters. The user may select the appropriate tab-and-cutout combination based on the specific vessel size, providing a customizable fit. The material thickness around the cutout 118 can be reinforced to prevent tearing or deformation during repeated use by such as, for example, local thickening of the material, addition of reinforcing strips, or incorporation of stronger materials such as fabric backing or polymer films in the cutout region. The reinforcement extends the operational life of the accessory 100 while maintaining the integrity of the tab-and-cutout engagement system.

In manufacturing the wrap, the decorative layer 106 is adhered to the magnetic layer 104 through a manual process involving the application of a strong adhesive, with pressure applied to ensure a firm bond between the two layers. To achieve the necessary curvature, the assembled wrap is tightly rolled and left in this configuration for a duration of 12-24 hours. In another embodiment, the accessory 100 may be packaged in a rolled configuration. This step allows the wrap to retain the cylindrical shape and ensure close contact with the tumbler surface upon application.

The accessory 100 offers broad variability in customization without constraints on the techniques used. Various printing methods, including screen printing, digital printing, UV printing, and others, can be employed to apply designs to the decorative layer. A range of inks and printing substances can be utilized, thereby not limiting the creative possibilities for personalization. The design layer can accommodate personalized photos, text, branded logos, licensed imagery, and other forms of graphic content. The accessory 100 can provide direct adherence of a thin, lightweight decorative layer to the vessel using a magnetic bond, minimal added bulk and weight, and a longer-lasting solution due to the durability of the materials used.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. For example, alternative adhesives may be employed to optimize the bonding process between the decorative layer and the magnetic layer. The dimensions of the wrap can be modified to fit various shapes and sizes of metal objects beyond insulated drinking vessels.

Lastly, the terminology used herein is for the purpose of describing particular embodiments only and is not intended to limit the scope of the present disclosure, which is defined solely by the claims. Accordingly, embodiments of the present disclosure are not limited to those precisely as shown and described. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A customizable accessory for steel-walled insulated drinking vessels, the drinking vessels having a vessel height and at least one vessel circumference, the accessory comprising:
a magnetic wrap configured to wrap about at least a portion of the vessel height and conform to the shape of the drinking vessel without an air gap, the magnetic wrap having a wrap height, at least one wrap length, and a wrap thickness, the magnetic wrap comprising:
a magnetic layer formed from a flexible magnetic material; and
a decorative layer made from a printable, wipe-clean material;
wherein said decorative layer is adhered to said magnetic layer using an industrial-strength adhesive.

2. The customizable accessory of claim 1, wherein the at least one vessel circumference is a first vessel circumference and a second vessel circumference and wherein the at least one wrap length is a first wrap length and a second wrap length, the first wrap length conforming to the first circumference and the second wrap length conforming to the second vessel circumference.

3. The customizable accessory of claim 2 wherein the first wrap length is connected to the second wrap length by at least one connector strip.

4. The customizable accessory of claim 3, wherein the at least one connector strip is about ½ inch long.

5. The customizable accessory of claim 1, wherein the accessory has a first end and a second end, and wherein the first and second ends are angled such that the first end matches with the second end when the accessory is wrapped about the vessel.

6. The customizable accessory of claim 1, wherein the magnetic layer provides a magnetic strength of at least 15 mil and a pull strength of at least 12.5 foot-pounds per square foot.

7. The customizable accessory of claim 1, wherein the thickness of the magnetic layer and the decorative layer combined ranges from 0.6 mm to 1.4 mm.

8. The customizable accessory of claim 1, wherein said industrial-strength adhesive is selected from the group consisting of 3M industrial hold spray adhesive and a two-compound resin adhesive.

9. The customizable accessory of claim 1, wherein the overall weight of the combined wrap is approximately 53 grams.

10. The customizable accessory of claim 1, wherein the dimensions of the wrap are approximately 3 inches in height and 12 inches in width.

11. The customizable accessory of claim 2, wherein the first wrap length is about 10 inches, and the second wrap length is about 12½ inches.

12. The customizable accessory of claim 2, wherein the accessory has a first edge and a second edge, wherein the first edge has the first wrap length and the second edge has the second wrap length and wherein the second wrap length is shorter than the first wrap length such that the accessory when wrapped about the vessel has a conical shape.

13. A method for manufacturing a customizable accessory for steel-walled insulated drinking vessels, the method comprising the acts of:
providing a magnetic layer formed from a flexible magnetic material,
providing a low-profile design layer having a design side and an adhesive side;
printing a design on the design side of the design layer;
applying an industrial-strength adhesive to the adhesive side of the design layer
applying the adhesive side of the design layer with the applied adhesive applied to the magnetic layer and applying pressure to bond the design layer with the magnetic layer.

14. The method of claim 13, further comprising forming a strip of the magnetic layer and the design layer having a first end and a second end and forming a crease the first end to form a snap flap.

15. The method of claim 13, further comprising rolling the combined magnetic and decorative layers tightly to retain a cylindrical shape for application to the drinking vessel.

16. The method of claim 15, further comprising maintaining the rolled combined layers in said cylindrical shape for a duration of 12 to 24 hours.

17. The method of claim 13, wherein the combined thickness of the magnetic layer and the design layer ranges from 0.6 mm to 1.4 mm.

18. The method of claim 13, wherein said industrial-strength adhesive is selected from the group consisting of 3M industrial hold spray adhesive and a two-compound resin adhesive.

19. The method of claim 13, wherein the overall weight of the combined accessory is approximately 53 grams.

20. The method of claim 13, wherein the dimensions of the accessory are approximately 3 inches in height and 12½ inches in width.
